(19) United States
(12) Patent Application Publication
(10) Pub. No.: US 2019/0227540 A1
(43) Pub. Date: Jul. 25, 2019

(54) MOVEMENT CONTROL FOR VEHICLE FORMATION

(71) Applicant: NOKIA TECHNOLOGIES OY, Espoo (FI)

(72) Inventor: Arto Kristian SUVITIE, Helsinki (FI)

(73) Assignee: NOKIA TECHNOLOGIES OY, Espoo (FI)

(21) Appl. No.: 16/257,177

(22) Filed: Jan. 25, 2019

(30) Foreign Application Priority Data
Jan. 25, 2018 (EP) 18153409.0

(51) Int. Cl. G05D 1/00; G01C 21/34; G08G 5/00

(52) U.S. Cl. CPC G05D 1/0027; G01C 21/3453; G05D 1/0094; G08G 5/0078; G08G 5/0039

(57) ABSTRACT

A first route from a first position to a target waypoint can be determined for a first vehicle. A first planned route from a second position to a planned waypoint for a second vehicle following the first vehicle can then be determined using a first mask positioned in a predefined manner relative to the first route. If it is determined that a direction of a second route for the first vehicle from the target waypoint to a next target waypoint is not substantially parallel with a direction of the first route, a second planned route for the second vehicle can be determined using a second mask positioned in a predefined manner relative to the second route. Movement of the second vehicle is controlled in response to determining a relation between the first planned route and the second planned route.

### CROSS-REFERENCE TO RELATED APPLICATIONS

This application claims priority to European Patent Application No. 18153409.0, filed Jan. 25, 2018, the entire contents of which are incorporated herein by reference.

### FIELD

This disclosure relates to apparatuses and methods for controlling movement of a formation of vehicles.

### BACKGROUND

A formation of moving vehicles can be provided, for example by but not limited to, aircrafts, cars, boats and the like.

The aircrafts may comprise, e.g., unmanned aerial vehicles (UAVs). UAVs are given herein as a more detailed but non-limiting example of vehicles that can move in a formation. Multiple terms are used for UAVs, which generally refer to the same concept. The term drone, more widely used by the public, was coined in reference to early remotely-flown target aircrafts used for practice firing of a battleship's guns. The term unmanned aircraft system (UAS) was adopted by the United States Department of Defence (DoD) and the United States Federal Aviation Administration in 2005 according to their Unmanned Aircraft System Roadmap 2005-2030. A UAV may be defined as a “powered, aerial vehicle that does not carry a human operator, uses aerodynamic forces to provide vehicle lift, can fly autonomously or be piloted remotely, can be expendable or recoverable, and can carry a lethal or nonlethal payload”. In the following, the term UAV is intended to cover all types of unmanned aircraft systems.

A single UAV can be used for a multitude of use cases. However, the use of several UAVs makes it possible to complete tasks, such as area search much more efficiently. A group of UAVs is often referred to as a fleet or a swarm. It has been determined that using multiple miniature UAVs to perform tasks is cheaper in both acquisition and maintenance in comparison to using a single large UAV. A fleet can cover a larger area faster before having to replace the batteries. UAV flight paths should not intersect and collisions should be avoided when making turns. UAVs following a leader should mat be left behind because information of the leader movements may be delayed by latency.

US2010/0168937 A1 discloses a flight control system for aircraft formation flight where flight trajectory of another vehicle is followed.

Sullivan, B.: “Capabilities of Flight Controllers for UAV Group Flight, s.l.”, Lehigh University, 2016, describes an algorithm to correct UAV flight paths to prevent crashes in case of arbitrary flight paths.

### SUMMARY

A first route from a first position to a target waypoint can be determined for a first vehicle. A first planned route from a second position to a planned waypoint for a second vehicle following the first vehicle can then be determined using a first mask positioned in a predefined manner relative to the first route. If it is determined that a direction of a second route for the first vehicle from the target waypoint to a next target waypoint is not substantially parallel with a direction of the first route, a second planned route for the second vehicle can be determined using a second mask positioned in a predefined manner relative to the second route. Movement of the second vehicle is controlled in response to determining a relation between the first planned route and the second planned route.

In accordance with an aspect there is provided a method comprising determining a first route from a first position to a target waypoint for a first vehicle, determining a first planned route from a second position to a planned waypoint for a second vehicle following the first vehicle using a first mask positioned in a predefined manner relative to the first route, determining that a direction of a second route for the first vehicle from the target waypoint to a next target waypoint is not substantially parallel with a direction of the first route, determining a second planned route for the second vehicle using a second mask positioned in a predefined manner relative to the second route, and controlling movement of the second vehicle in response to determining a relation between the first planned route and the second planned route.

In accordance with another aspect there is provided an apparatus comprising at least one processor and at least one memory including computer program code, the at least one memory and the computer program code configured to, with the at least one processor, cause the apparatus at least to perform determining a first route from a first position to a target waypoint for a first vehicle, determining a first planned route from a second position to a planned waypoint for a second vehicle following the first vehicle using a first mask positioned in a predefined manner relative to the first route, determining that a direction of a second route for the first vehicle from the target waypoint to a next target waypoint is not substantially parallel with a direction of the first route, determining a second planned route for the second vehicle using a second mask positioned in a predefined manner relative to the second route, and controlling movement of the second vehicle in response to determining a relation between the first planned route and the second planned route.

In accordance with another aspect there is provided a computer program comprising program instructions for causing a computer to perform a method comprising at least to determining a first route from a first position to a target waypoint for a first vehicle, determining a first planned route from a second position to a planned waypoint for a second vehicle following the first vehicle using a first mask positioned in a predefined manner relative to the first route, determining that a direction of a second route for the first vehicle from the target waypoint to a next target waypoint is not substantially parallel with a direction of the first route, determining a second planned route for the second vehicle using a second mask positioned in a predefined manner relative to the second route, and controlling movement of the second vehicle in response to determining a relation between the first planned route and the second planned route.

Determining relation between planned routes for at least one second vehicle can comprise determining whether the masks overlap or are separated.

At least one of a speed, an acceleration, a direction of movement and a position of a next planned waypoint of the second vehicle may be controlled in response to the determining of a relation between the first planned route and the second planned route.

A length of one side of a rectangular mask can substantially equal the length of the first or second route of the first vehicle and extend in parallel with said route. A second substantially parallel side of the rectangular mask can then represent a corresponding first or second planned route of the second vehicle.

It can be determined that the masks overlap. In response thereto the first planned route may be shortened by moving the planned waypoint towards the second position and generating a new starting point for the second planned route at a side of the second mask extending substantially in parallel with the second route between first and second ends of the second mask. If it is determined that the masks are separated, an additional route segment may be generated for the second vehicle between the planned waypoint and a next planned waypoint, wherein the next planned waypoint comprises a planned starting point of the second planned route at an edge of the second mask.

According to a yet further aspect there may be provided a method comprising designating a vehicle (e.g. a leader of a vehicle formation); and determining a position of the designated vehicle. At least one planned target waypoint for the designated vehicle may be determined to form a route between the determined position and the at least one planned target waypoint. A planned other waypoint for another vehicle (e.g. a follower of a vehicle formation) may be determined by a rectangle with one side being the formed route and the other substantially parallel side of substantially same length representing a planned route of the other vehicle between a starting point of the other vehicle and the planned other waypoint; whereafter the planned other route of the other vehicle may be changed by moving the planned other waypoint of the other vehicle if a direction of a next route of the designated vehicle towards the next planned target waypoint of the designated vehicle is not substantially parallel to a direction of the route of the designated vehicle.

The method may further comprise increasing the speed and/or acceleration of the other vehicle if a distance between the planned other waypoint of the other vehicle and the determined position of the designated vehicle exceeds a predetermined threshold.

The method may further comprise controlling the determination of the planned other waypoint of the other vehicle so that the planned other waypoint is not set further towards the direction of the formed route (i.e. movement direction of the vehicle formation) than the next planned target waypoint of the designated vehicle.

The method may further comprise controlling the determination of the planned other waypoint of the other vehicle so that if the designated vehicle has more than one waypoint remaining, the following waypoint of the designated vehicle determines the maximum amount of a predetermined spatial offset for the other vehicle.

The method may further comprise controlling the determination of the planned other waypoint of the other vehicle so that the planned other waypoint does not intersect with the formed route of the designated vehicle.

The method may further comprise controlling the amount of the planned route of the other vehicle between successive planned other waypoints so that the planned route never extends past corners of the formed route of the designated vehicle.

The method may further comprise generating a formation of the designated vehicle and at least one other vehicle based on predetermined parameters provided to the formation.

The method may further comprise causing to change to cover also causing to update.

Generating the vehicle formation based on predetermined parameters provided to the vehicle formation may further comprise setting the predetermined parameters by placing markers on a grid of a user interface.

The providing step may comprise periodically sending the planned target waypoints to the other vehicle(s).

The method may further comprise providing values of a planned flight altitude and field of view angles to respective payload cameras of the other vehicles and using the provided values to automatically determine a predetermined spatial offsets for the other vehicles.

The method may further comprise initially generating a vehicle formation as a line formation, checking a predetermined minimum distance between each of the designated and other vehicles of the vehicle formation, and moving every other one of the other vehicles backwards so that a sideway spacing between the other vehicles substantially remains the same.

The method may further comprise calculating the sideway spacing between the other vehicles based on a horizontal camera angle, an altitude and a required minimum camera footage overlap of the respective payload cameras.

According to an aspect there is provided an apparatus comprising means for designating a vehicle (e.g. a leader of a vehicle formation); means for determining a position of the designated vehicle; means for determining at least one planned target waypoint for the designated vehicle to form a route between the determined position and the at least one planned target waypoint; means for determining a planned other waypoint for another vehicle (e.g. a follower of a vehicle formation) by a rectangle with one side being the formed route and the other substantially parallel side of substantially same length representing a planned route of the other vehicle between a starting point of the other vehicle and the planned other waypoint; and means for causing to change the planned other route of the other vehicle by moving the planned other waypoint of the other vehicle if a direction of a next route of the designated vehicle towards the next planned target waypoint of the designated vehicle is not substantially parallel to a direction of the route of the designated vehicle.

According to an aspect there is provided an apparatus comprising means for performing the actions of the method as described above.

According to another aspect there is provided an apparatus configured to perform the actions of the method as described above.

The computer program product may be stored on a medium and may cause an apparatus to perform the method as described herein.

According to an aspect a device for controlling a vehicle formation may comprise apparatus as described herein. The device may be provided at a central ground station or at another vehicle. The device may be handheld.

According to an aspect an apparatus comprising at least one processing core, at least one memory including computer program code, the at least one memory and the computer program code being configured to, with the at least one processing core, cause the apparatus at least to determine a position of a vehicle, determine at least one planned target waypoint for the designated vehicle to form a route between the determined position and the at least one planned target waypoint, determine a planned other waypoint for another vehicle by a mask with one side being the formed route and the other substantially parallel side of substantially same length representing a planned route of the other vehicle between a starting point of the other vehicle and the planned other waypoint, and change the planned other route of the other vehicle by moving the planned other waypoint of the other vehicle if a direction of a next route of the designated vehicle towards the next planned target waypoint of the designated vehicle is not substantially parallel to a direction of the route of the designated vehicle.

According to another embodiment, the proposed vehicle formation control approach could be used in connection with autonomous cars when e.g. two cars in different lanes are approaching a curve.

A chipset may comprise the apparatus as described herein.

### SUMMARY OF THE FIGURES

For a better understanding of the present application, reference will now be made by way of example to the accompanying drawings in which:

FIG. 1 shows schematically a system for flight control of an aircraft formation;

FIGS. 2a-2d show schematically different flight control scenarios of an aircraft formation;

FIG. 3a-3c show schematically a representation of a flight path determination according to some examples;

FIG. 4 shows a flow diagram according to an example;

FIG. 5 shows a flow diagram according to another example;

FIG. 6 shows schematically an example of a control interface for adjusting aircraft parameters; and

FIG. 7 shows a schematic example of a control apparatus.

### DETAILED DESCRIPTION

The following describes in further detail examples of suitable systems, apparatuses and possible mechanisms for controlling movement of follower vehicles. The illustrative and non-limiting examples are given with reference to flight of a formation of UAVs. It is however noted that the described embodiments may also be implemented in other systems, apparatuses and possible mechanisms for controlling the movement of a formation of other vehicles, such as cars, ships etc.

A fleet of UAVs can be scaled up to provide better coverage and endurance. For example, a failure of a single UAV will not compromise the entire mission. Implementing a UAV fleet solution brings its own set of challenges. The user may need to be able to monitor the status of all UAVs in real time. Also, mechanisms to prevent collisions between the UAVs might be desired. It might also be desirable for the control network to be capable of providing high bandwidth and low latency. This may be especially important in search-and-rescue (SAR) operations. Task assignment for large numbers of UAVs can have a high combinatorial complexity. Centralized fleet control architectures can suffer from communication overhead. Decentralized architectures may become sensitive to information discrepancies across UAVs, which may lead to conflicting decisions.

Missions for a UAV fleet can be either pre-planned or real-time. A fleet may move in a formation or separately. Pre-planned missions have the benefit of working even with poor connectivity. Real-time missions may be interrupted or run into risk of collisions when messages do not reach their endpoints. When the fleet is moving in formations or organized swarms, it is possible to have one or more UAVs flying on a higher altitude to act as coordinators for the operation.

UAVs can be used for various purposes. For example, performing search operation of a missing or another person with UAVs instead sending people to survey an area is a way to increase speed and area coverage of the search. As an example, a search method has been proposed for completely autonomous UAVs, in which the target area is split into cells and UAVs mark visited cells to be avoided by their peers. This may enable the search can be carried out without a complete pre-set flight plan. This method was inspired by insects that use pheromones to guide their peers. Another proposed search method is called gradient optimization, where an uncertainty map is generated for the search area by surrounding points of interest with gradually decreasing uncertainty. The UAVs then autonomously search the area, trying to cover most of the uncertain territory, while avoiding collisions.

There are different approaches to scale up search methods for a multi-UAV scenario. An approach is to organize the UAV fleet into a search formation, which can then be considered as a single unit with a considerably larger field of view. When a search pattern is generated for such a formation, the lines of the path will be much further apart and the area is covered quicker. Another approach is to split the search area (e.g., by using Voronoi tessellation on points of interest) into separate sub-areas, and allocating a single UAV to each area. This approach may not be as easy to accomplish as the formation search, but can be used to reduce flight time, and thus improve the performance.

The above approaches can also be combined to have individual UAVs and small UAV formations, each working on their own designated areas. Finding out the appropriate approach for different scenarios is something that needs to be determined on a case by case basis. Each individual UAV may be controlled separately at a time by the currently commercially available control software. However, it might be desirable to be able to control movement of a multiple of UAVs and other vehicles moving in a formation. In certain specific occasions it might also be desirable to provide at least one of a map that displays UAV location and routes, waypoint-based route planning, real-time UAV status display, UAV mission controls, real-time guided waypoint control, simultaneous connection to multiple UAVs, simultaneous control of multiple UAVs, planning of multiple routes, and swarm formation support.

There are certain issues in providing formation control. For example, a leader UAV might end up flying several meters ahead of the others, turning a line formation into a V formation. This asynchronous behaviour is partially caused by latency. If the waypoints for each UAV are calculated as offsets of the last known location of the leader UAV, the communications delay between a ground station and the UAVs needs to be considered. Delay issues may occur where the connections are based on traditional radio links as well as with cellular communication technologies (e.g. 4^{th} or 5^{th} Generation mobile systems).

FIG. 1 shows schematically an exemplary system for flight control of an aircraft formation with three UAVs 12, 14, 16 flying in formation. One UAV 12 is designated as the leader (L) flown on the mission flight path by a flight control unit 100 (e.g. command and control ground station) while the remaining other UAVs 14, 16 are followers (F1, F2) that are led by being tracked in dependence on the position of the leader UAV 12. In an echelon formation, as depicted in FIG. 1, the leader UAV 12 is leading the two follower UAVs 14, 16. Of course, there may be more than two followers, i.e., more than one on at least one side of the leader. Each UAV is provided with appropriate control apparatus 13, 15 and 17. Further, communication apparatus for enabling wireless communications designated by the double ended arrows 10 between the UAVs and flight control unit 100. The UAVs may also be configured for wireless communications between each other.

The initiation of an automatic formation flight and the formation parameters can be controlled via uplink commands transmitted from the flight control unit 100. Discrete uplinks may be used for enabling an airborne UAV formation control unit provided by the respective control apparatus. A formation control unit is at least provided in each of the follower UAVs 14, 16 to take control of the respective UAV. Additionally, appropriate downlink telemetry can be supplied by each airborne UAV formation control unit for ground control monitoring at the flight control unit 100.

The configuration of the flight control unit 100 may vary. Ground station control may be provided by manually operated control consoles and/or pre-programmed computers with respective user interfaces. In a minimal command/control system, one multiplexed flight control unit 100 can launch multiple UAVs into a formation flight. By “multiplexed” it is meant that the flight control unit 100 sequentially provides uplinks and receives downlinks to/from UAVs to be flown in a mission, while providing controller inputs for command uplinks to controller-selected UAVs.

In accordance with a possible procedure the flight control unit 100 may select and launch a first, or a leader UAV 12 and may place it in a hold pattern (e.g. orbit mode). The flight control unit 100 may then select and launch each successive UAV in the appropriate follower order. When all UAVs for the formation flight are flying in formation in the hold pattern, the flight control unit 100 may again take control of the leader UAV 12 and start control of the formation mission as explained in the following.

According to an example, the flight control system can be based on the latest known position of the leader UAV 12 only. Then, target waypoint locations (target waypoints) for the follower drones 14, 16 are first determined (e.g. calculated as an offset from the leader location) and then the point was projected forwards to compensate for any delays. As a result, even if there were some gaps in communication, the follower UAVs 14, 16 would still keep flying in the right direction for a while, instead of immediately stopping to wait for further commands.

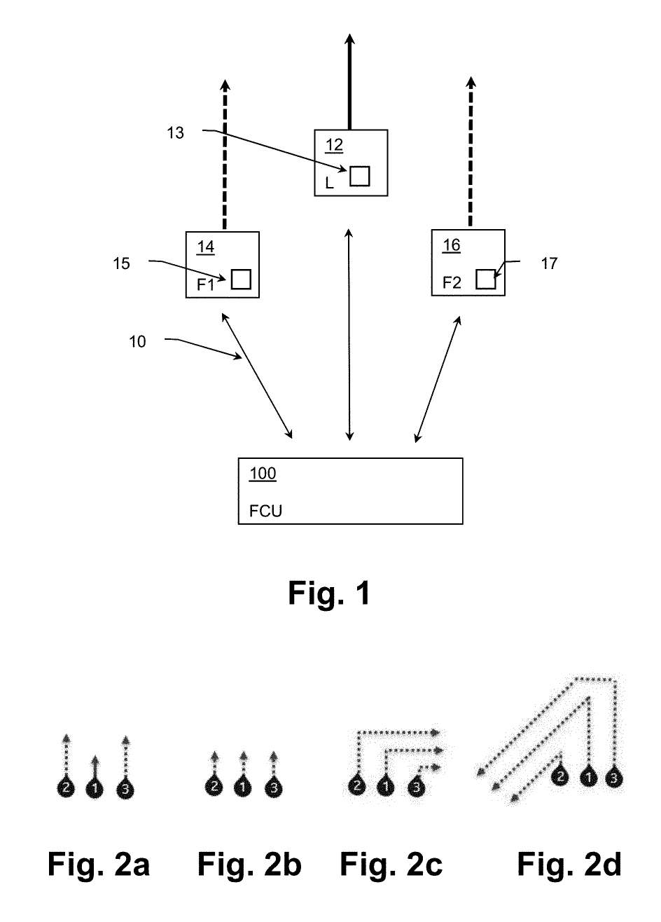

FIGS. 2a-2d show schematically different specific flight control scenarios of an aircraft formation and resulting requirements on the above flight control approach.

In the scenario of FIG. 2a, the leader UAV 1 is controlled manually (no known waypoint), while the follower UAVs 2, 3 are provided with waypoints with offset towards the leader's flight direction. Here, the offset distance is proposed to be determined based on the flight speed.

In the scenario of FIG. 2b, the leader UAV 1 is provided with a single waypoint (e.g., guided waypoint or last mission waypoint) and the waypoint offsets for the follower UAVs 2, 3 are proposed to be limited to never go ahead of the next leader's waypoint.

In the scenario of FIG. 2c, the leader UAV 1 is provided with more than one waypoint (mission) and the waypoint offsets for the follower UAVs 2,3 are limited according to the next two waypoints. Here, the offset distance is proposed to be determined in dependence on the angle from leader's current waypoint to the next one. Moreover, the flight paths are proposed to be set to never intersect.

Finally, in the scenario of FIG. 2d, the leader UAV 1 is provided with waypoints at a sharp angle. In this case, it is proposed to have the follower UAV 3 in the outer curve go through an additional waypoint to keep the path from becoming too long, and to have the follower UAV 2 in the inner curve stop the intended waypoint path and turn earlier before the next waypoint to avoid crossing leader's flight path.

Based on the above scenarios and proposals a corresponding flight control procedure according to some embodiments is described in the following.

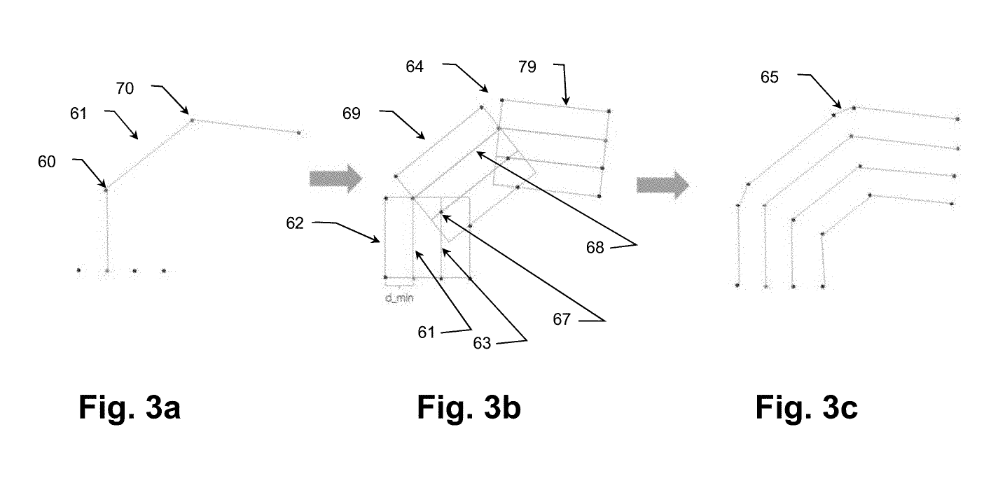

FIGS. 3a, b and c show schematically a representation of an exemplary flight path determination for three sidewise neighbouring follower UAVs based on waypoints of a flight path 61 of a designated leader UAV. More particularly, the example describes from the left to the right how the flight path 62 of the left sidewise neighbouring follower UAV and the flight paths 63 of the two right sidewise neighbouring follower UAVs are initiated based on the flight path 61 of the designated leader UAV. In the example of FIGS. 3a-c, segments of the flight paths are determined based on calculated and probably corrected waypoints and determination masks having rectangular shape. The determination mask provides a window that can be used for determining relations between movement paths of the vehicles such as the UAVs.

First, the route or path 61 of the leader UAV is planned by determining target waypoints for the leader UAV (FIG. 3a). Then, rectangles are overlaid on or added to or incorporated into the planned route so that each follower UAV is maintained at a predefined minimum lateral distance dₘᵢₙ from the neighbouring UAV in the formation (FIG. 3b). Finally, the routes or paths of the follower UAVs are planned based on the dimensions of the rectangles and possibly corrected based on their overlap or non-overlap.

The planned new waypoints for the paths or routes of the follower UAVs are obtained by a respective rectangle. In the example one side of the respective rectangle is the planned path 61 of the leader UAV and the other substantially parallel side of substantially same length represents the planned paths 62, 63 for the neighbouring follower UAV between a starting point of the respective follower UAV and its planned next waypoint. Based on the location of the respective rectangle, the planned paths 62, 63 of the follower UAVs is changed by moving or correcting the planned new waypoint of the respective follower UAV if the direction of the path 61 towards the next planned target waypoint of the designated leader UAV is not substantially parallel to a direction of the previous route.

More specifically, corrections of planned new waypoints can be obtained from rectangles which are determined in lateral direction by the required distance between the flight paths and in longitudinal direction by the distance between the waypoints of the central flight path 61 of the leading UAV. Target waypoints for the left and right follower UAVs are corrected, e.g., (i) if the flight path to the next calculated waypoint crosses an outer edge of the next rectangle or (ii) if the next calculated waypoint is outside the next rectangle. In the first case (i), the target waypoint of the corresponding follower UAV is shifted backwards to match with the crossing point, so that the respective path segment 63 is shortened. In the second case (ii), a gap 64 is generated and an additional target waypoint and thus an additional path segment 65 is added to path 62 to match with the respective corner of the rectangle. Thereby, as depicted in the scenario of FIG. 2d, the flight path of a follower UAV in the outer curve is controlled to be routed through additional waypoints to keep the path from becoming too long, and the flight path of a follower UAV in the inner curve is controlled to be stopped and turned earlier before the next waypoint to avoid crossing the leader's flight path.

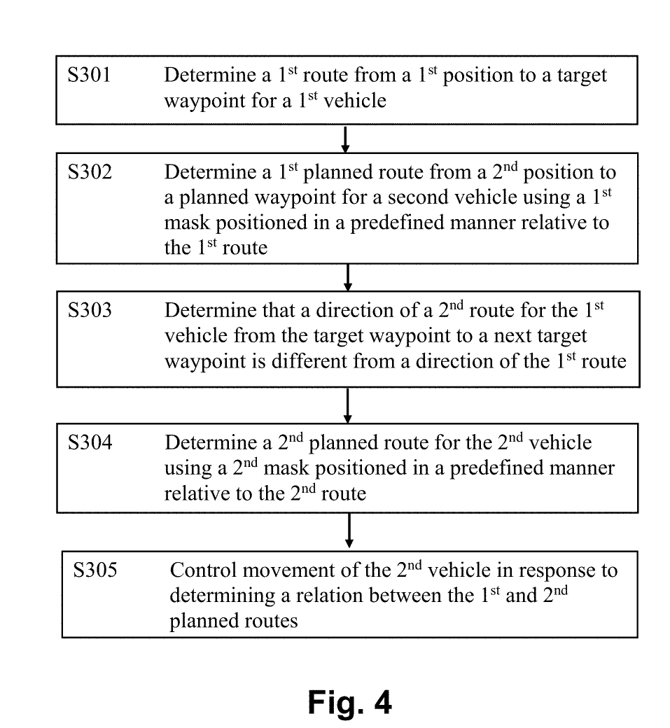

FIG. 4 shows a flow diagram according to a possible operational scenario for movement control. In the shown method comprising a first route from a first position to a target waypoint is determined for a first vehicle at S301. A first planned route from a second position to a planned waypoint for a second vehicle following the first vehicle is determined at S302 using a first mask positioned in a predefined manner relative to the first route. In FIG. 3b a plurality of first masks is illustrated in the lowest block where rectangle shaped masks are provided in either side of the flight path 61 of the leader.

It can then be determined at S303 that a direction of a second route for the first vehicle from the target waypoint to a next target waypoint is not substantially parallel with a direction of the first route. FIGS. 3a-c show the flight path 61 to turn to the right at point 60, and again at 70. A second planned route for the second vehicle can then be determined at S304 using a second mask positioned in a predefined manner relative to the second route of the first device. In FIG. 3b this is illustrated by to the right tilted block of rectangular masks 69 and again by the block of rectangular mask 79 after a second turn to the right by the leader.

Movement of the at least one second vehicle can be controlled at S305 in response to determining a relation between the first planned route and the second planned route. According to an example this is based on determining whether the masks before and after a turn overlap or are separated.

As explained above, in response to determining that the masks overlap, the first planned route may be shortened by moving the planned waypoint towards a second position and generating a new starting point for the second planned route at an side of the second mask extending substantially in parallel with the second route between first and second ends of the second mask. In FIG. 3b this is illustrated by the shortening of path 63 and point 67 on the side of the rectangular mask designating the flight path 63. On the other hand, in response to determining that the masks are separated, as is the case with flight path 62 in FIG. 3b, an additional route segment 65 can be generated for the second vehicle to “fill” the void 64 between a planned waypoint and a next planned waypoint, the next planned waypoint comprising a planned starting point of the second planned route at an edge of the second mask.

The method may comprise controlling at least one of a speed, an acceleration, a direction of movement and a position of a next planned waypoint of the second vehicle in response to the determining of a relation between the first planned route and the second planned route.

In FIG. 3b example the mask comprises a rectangle, and the arrangement can be such that the length of one side of the rectangle substantially equals the length of the relevant route of the first vehicle and extends in parallel with said route, and wherein a second substantially parallel side of the rectangle represents a corresponding planned route of the second vehicle. However, differently shaped mask may be used. For example, four sided mask wager at least two of the sides are not parallel and/or the two opposing sides are not of the same length and/or the corners are not normal are possible. Three sided or five sided mask may be used. For example, a mask may have the shape of a trapezoid, a trapezium, parallelogram, rhombus, triangle and so forth. The shape can be reconfigurable. Different shapes can be used for achieving different movement patterns and features.

The control procedure can be implemented by concrete hardware circuits having one or more functions of the blocks of the flow diagram or by a software routine which controls a processor of a computer to generate the steps of the flow diagram. The hardware circuits or the processor and computer may be part of the flight control unit 100 of FIG. 1. In the latter case, the methods described herein are implemented by corresponding means of an apparatus.

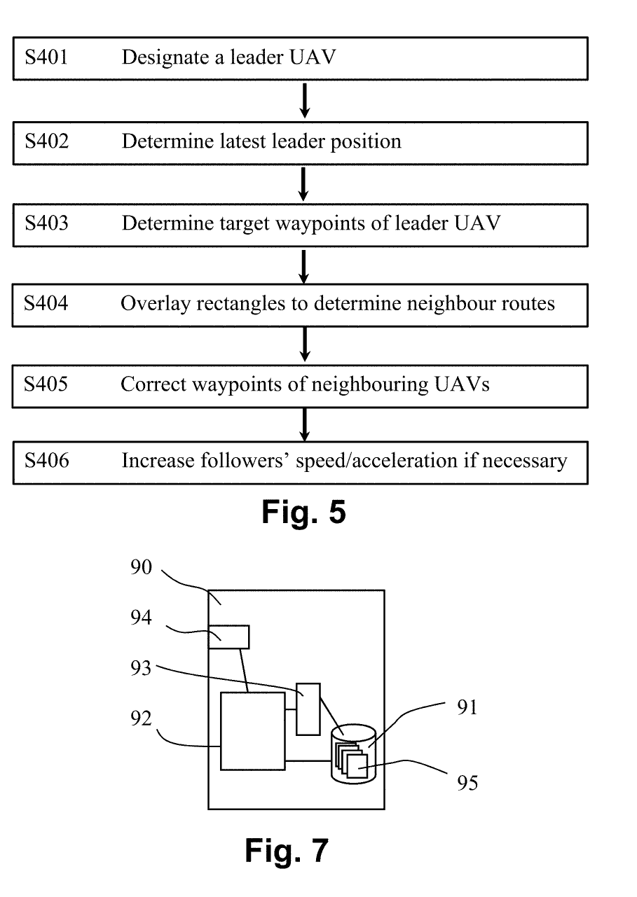

FIG. 5 shows a flow diagram of a detailed example for a flight control procedure according to some embodiments. In step S401 (e.g. means for designating), a leader UAV is designated, e.g., based on a corresponding setting at a user interface. Then, in step S402 (e.g. means for determining), the latest position of the leader UAV is determined, e.g. based on a corresponding information (e.g. positioning signal etc.) received from the leader UAV. In the following step S403 (e.g. means for determining), target waypoint locations (target waypoints) for the leader UAV are first determined e.g. based on a planned flight path. Thereafter, in step S404 (e.g. means for determining), rectangles are overlaid to determine planned waypoints for the routes or paths of neighbouring follower UAVs, as described above in connection with FIGS. 3 a-c. The determined planned waypoints may for example be projected forwards to compensate for any delays caused by e.g. the communication between the UAVs and the flight control unit and/or the processing at the UAVs and/or the flight control unit and/or other delays until the target waypoints are available. Then, in step S405 (e.g. means for changing) the determined planned waypoints are for the follower UAVs are corrected based on the location and orientation of the rectangles, so that their paths are automatically adapted to the flight path of the leader UAV and utilizing drain.

As a result, even if there were some gaps in communication, the follower UAVs would still keep flying in the right direction for a while, instead of immediately stopping to wait for further commands.

As an example, the delays can be compensated for in step S404 by offsetting the follower target waypoints forwards by a few meters.

Also, another optional feature may be implemented as an additional step S406 (e.g. means for increasing), in which a follower's speed and/or acceleration is automatically increased if the respective follower UAV fell too far behind from its next target waypoint. Thereby, the UAVs of the flight formation can be controlled to keep up with the formation and catch up when necessary.

As mentioned above, corrections for avoiding collision risks depending on specific flight paths of search patterns or a phase of search patterns controls can be added in step S405 so that a follower UAV's planned waypoint could never be set further than the next waypoint of the leader UAV. More specifically, this can be achieved by limiting the target waypoint offset to never go past corners in a flight path, offsetting target waypoints forwards towards the flight direction or adding target waypoints to counter latency effects and keep the formation in shape, limiting follower target waypoints so that they will never intersect with the leader flight path when the leader flight path is known in advance, etc.

According to another embodiment, the proposed vehicle formation control approach could be used in connection with autonomous cars when, e.g., two cars in different lanes are approaching a curve. Then, the route or path could be calculated using the rectangular approach described above. The calculation or determination of rectangles or otherwise shaped masks could be repeated when the cars are driving in the curve to keep a desired minimum distance. In this embodiment, the length of the cars might need to be taken into consideration. I.e., the proposed masks may be used at the back, center and front of the cars to keep the distance and adjust the speed as well.

In another embodiments roads are usually split to lanes. Autonomous cars are driving in lanes and there the cars in different lanes may have same waypoints and sometimes roads have curves. The cars in different lanes should keep minimum distance between each other. The planned path could be built to cars which will drive side by side so that, e.g., the centre of lane representing the path and then the cars width and length could be taking into account to keep the predetermined distance when planning path so that the cars would not run up especially in cases when two or more lanes are curved to the same direction.

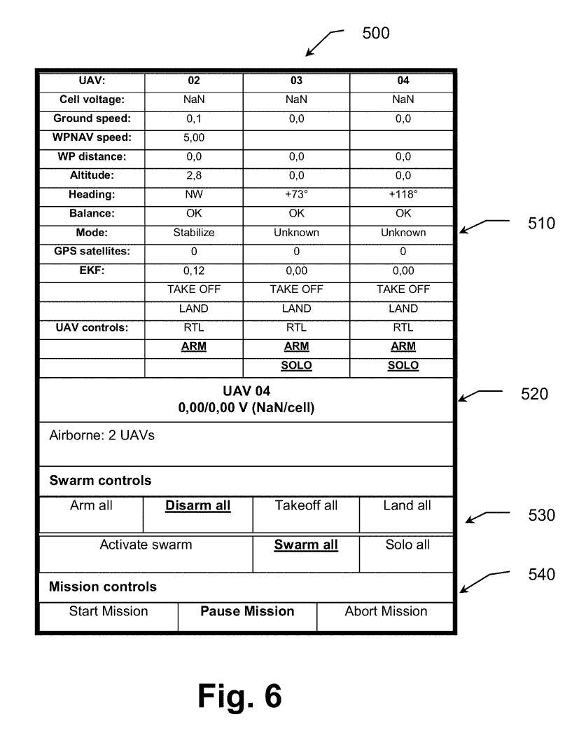

In the following, specific examples for design and functionality of user interfaces (e.g. touch-control displays) at the flight control unit or another vehicle formation control unit are described with reference to FIG. 6. FIG. 6 shows schematically a representation of a control interface for adjusting aircraft parameters according to some embodiments.

Options for individually adjusting the extra speed of a follower and the threshold for activation for each UAV can be seen in an upper control section 510 of the user interface. Thereby, a user is allowed to fine tune the behaviour of the UAV formation in real time. Of course, such a compensation could as well be done automatically under control of a respective software routine.

In a display window 520, specific information of a selected UAV can be displayed. Additionally, in a lower section 540, mission control buttons are provided for starting, pausing and aborting a current mission.

However, such changed settings can also introduce a collision risk when performing standard lawnmower pattern paths, since just before the leader UAV (drone) was to reach a corner, the follower UAVs (drones) would still be instructed to fly forward with given offsets, as already explained above, e.g., in connection with FIGS. 2a-2d and 3a-3c. This meant that for a while the leader UAV's and follower UAVs' paths would intersect until a new target waypoint was provided to the respective follower UAV. As explained above, this can be prevented by making sure that a follower UAV's offset target waypoint can never be set further than the next waypoint of the leader UAV. Furthermore, this control condition can be refined so that if the leader UAV had more than one waypoint remaining, the following waypoint could also be considered to determine a maximum offset for a follower UAV.

The proposed corrections for collision prevention can be used to improve the formation flight by reducing the impact of latency and by preventing the UAVs from crashing into each other. However, even with these corrections, the provisioning of periodic waypoint commands from a ground station (e.g. flight control unit) may in certain conditions still lead to a suboptimal and unreliable control for coordinated formation of vehicles. E.g., if a user accidentally closes the control window, the control routine may immediately stop giving new waypoint commands to the follower UAVs, leaving the leader UAV to continue the mission alone.

In view of this, a swarming functionality in a swarm control section 530 is proposed as a part of the user interface of FIG. 6, where the UAV offsets are defined. The above problem can thus be solved by moving the functionality over to an automatic swarm control as part of a main routine of the control software.

A control interface for defining offsets and arbitrary formations according to some embodiments provides a UAV swarming control function as a basis for implementing formation-based drone flights. This swarming control function allows to designate one UAV as a leader and other connected UAVs as followers. The follower UAVs are periodically sent guided waypoints, that are calculated as offsets from the leader's location, as described above, e.g., with reference to FIGS. 3a-3c to 5.

With the control interface the user can drag UAV markers on a grid to define desired offsets and make up arbitrary formations. On the grid, the ‘up’ or vertical direction points towards the facing direction of the leader UAV.

As an additional option, the flight formation could be generated based on parameters, so that a user does not have to spend time manually adjusting the flight formations.

Instead of having to manually specify the UAV offsets, the user is may be allowed to input a planned flight altitude and a field of view angles of payload cameras arranged on the UAVs. These values can now be used to automatically generate a flight formation structure that would keep the UAVs optimally spaced apart to both cover maximum area and to keep safe distances to each other. The generated flight formation may start out as a line, where the distance between the UAVs is calculated e.g. from a horizontal camera angle, an altitude, and a required minimum overlap of camera footages. After this, the specified minimum safety distance between the UAVs is checked. If the UAVs are too close to each other in the line formation, then every other UAV is moved backwards so that the sideways spacing between the UAVs remains the same and guarantees full area coverage by the footages, while the added backwards spacing ensures safe distances between the UAVs. Thus, if backwards spacing needed to be added, then the straight-line formation turns into a zigzag formation.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the flight control unit, or by hardware, or by a combination of software and hardware. Further in this regard it should be noted that any blocks of the logic flow, e.g., as in FIGS. 4 and 5, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

FIG. 7 shows an example of control apparatus for a device capable of processing the above described actions of controlling movement of devices based on movement of a first device. The control apparatus 90 can be for example integrated with, coupled to and/or otherwise controlling a ground controller apparatus 100 of FIG. 1. The control apparatus can be fixedly located or mobile. The control apparatus may also be provided in a handled device. For this purpose the control apparatus comprises at least one memory 91, at least one data processing unit 92, 93 and an input/output interface 94. The database 91 can comprise entries 95 for various control instructions. Via the interface the control apparatus can be coupled to other elements of a data communication network. The control apparatus can be configured to execute an appropriate software code to provide the control functions. The control apparatus can also be interconnected with other control entities.

At least a part of the control operations may be provided by control apparatus provided on one of the vehicles.

The various embodiments and their combinations or subdivisions may be implemented as methods, apparatuses, or computer program products. Methods for downloading computer program code for performing the same may also be provided. Computer program products may be stored on non-transitory computer-readable media, such as memory chips, or memory blocks implemented within the processor, magnetic media such as hard disk or floppy disks, and optical media such as for example DVD and the data variants thereof, CD, magnetic disk, or semiconductor memory. Method steps may be implemented using instructions operable to cause a computer to perform the method steps using a processor and a memory. The instructions may be stored on any computer-readable media, such as memory or non-volatile storage. The foregoing description has provided by way of exemplary and non-limiting examples a full and informative description of exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of the herein disclosed invention.

That which is claimed is:

1. A method comprising:
determining a first route from a first position to a target waypoint for a first vehicle;
determining a first planned route from a second position to a planned waypoint for a second vehicle following the first vehicle using a first mask positioned in a predefined manner relative to the first route;
determining that a direction of a second route for the first vehicle from the target waypoint to a next target waypoint is not substantially parallel with a direction of the first route;
determining a second planned route for the second vehicle using a second mask positioned in a predefined manner relative to the second route; and
controlling movement of the second vehicle in response to determining a relation between the first planned route and the second planned route.

2. The method as claimed in claim 1, comprising controlling at least one of a speed, an acceleration, a direction of movement and a position of a next planned waypoint of the second vehicle in response to the determining of a relation between the first planned route and the second planned route.

3. The method as claimed in claim 1, wherein at least one of the masks comprises a rectangle.

4. The method as claimed in claim 3, wherein the length of one side of the rectangle substantially equals the length of the first or second route of the first vehicle and extends in parallel with said route, and wherein a second substantially parallel side of the rectangle represents a corresponding first or second planned route of the second vehicle.

5. The method as claimed in claim 1, wherein the determining of the relation between the planned routes for the second vehicle comprises determining whether the masks overlap or are separated.

6. The method as claimed in claim 1, comprising at least one of:
taking a control action in response to determining that a distance between the planned waypoint of the second vehicle and the first position of the first vehicle exceeds a predetermined threshold,
controlling the determination of the planned waypoint of the second vehicle so that the planned waypoint is not set further towards the direction of the first route than a next planned target waypoint of the first vehicle,
controlling determination of a planned waypoint for the second vehicle so that if the first vehicle has more than one waypoint remaining, the following waypoint of the first vehicle determines the maximum amount of a predetermined spatial offset for the second vehicle,
controlling the determination of a planned waypoint for the second vehicle so that the planned waypoint does not intersect with a determined route of the first vehicle, and
controlling length of a planned route of the second vehicle between successive planned waypoints so that the planned route does not extend past turning points of the first vehicle.

7. The method as claimed in claim 1, further comprising generating a formation of the first vehicle and at least one second vehicle based on predetermined parameters provided for the formation.

8. The method as claimed in claim 1, wherein the first and second vehicles comprise unmanned aerial vehicles, the method comprising providing values of a planned flight altitude and field of view angles to respective payload cameras of the second vehicle and using the provided values to automatically determine a predetermined spatial offset for the second vehicle.

9. The method as claimed in claim 1, further comprising initially generating a vehicle formation as a line formation of the first vehicle, the second vehicle and at least one further vehicle, checking a predetermined minimum distance between each of the vehicles of the vehicle formation, and moving every other one of the vehicles backwards so that a sideway spacing between the vehicles remains substantially the same.

10. An apparatus comprising at least one processor and at least one memory including computer program code, the at least one memory and the computer program code configured to, with the at least one processor, cause the apparatus at least to perform:
determining a first route from a first position to a target waypoint for a first vehicle;
determining a first planned route from a second position to a planned waypoint for a second vehicle following the first vehicle using a first mask positioned in a predefined manner relative to the first route;
determining that a direction of a second route for the first vehicle from the target waypoint to a next target waypoint is not substantially parallel with a direction of the first route;
determining a second planned route for the second vehicle using a second mask positioned in a predefined manner relative to the second route; and
controlling movement of the second vehicle in response to determining a relation between the first planned route and the second planned route.

11. The apparatus as claimed in claim 10, configured to control at least one of a speed, an acceleration, a direction of movement and a position of a next planned waypoint of the second vehicle in response to the determining of a relation between the first planned route and the second planned route.

12. The apparatus as claimed in claim 10, configured to process at least one of the determination based on a mask comprising a rectangle.

13. The apparatus as claimed in claim 12, wherein the length of one side of the rectangle substantially equals the length of the first or second route of the first vehicle and extends in parallel with said route, and wherein a second substantially parallel side of the rectangle represents a corresponding first or second planned route of the second vehicle.

14. The apparatus as claimed in claim 10, configured to determine the relation between the planned routes for the second vehicle based on determination whether the masks overlap or are separated.

15. The apparatus as claimed in claim 14, configured to:
in response to determining that the masks overlap, shorten the first planned route by moving the planned waypoint towards the second position and generate a new starting point for the second planned route at an side of the second mask extending substantially in parallel with the second route between first and second ends of the second mask, and
in response to determining that the masks are separated, generate an additional route segment for the second vehicle between the planned waypoint and a next planned waypoint, wherein the next planned waypoint comprises a planned starting point of the second planned route at an edge of the second mask.

16. The apparatus as claimed in claim 10, configured at least one of:
to take a control action in response to determining that a distance between the planned waypoint of the second vehicle and the first position of the first vehicle exceeds a predetermined threshold,
to determine the planned waypoint of the second vehicle so that the planned waypoint is not set further towards the direction of the first route than a next planned target waypoint of the first vehicle,
to determine a planned waypoint for the second vehicle so that if the first vehicle has more than one waypoint remaining, the following waypoint of the first vehicle determines the maximum amount of a predetermined spatial offset for the second vehicle,
to determine a planned waypoint for the second vehicle so that the planned waypoint does not intersect with a determined route of the first vehicle,
to control length of a planned route of the second vehicle between successive planned waypoints so that the planned route does not extend past turning points of the first vehicle,
to generate a formation of the first vehicle and at least one second vehicle based on predetermined parameters provided for the formation, and
to periodically send planned target waypoints to the second vehicle.

17. The apparatus as claimed in claim 10, wherein the first and second vehicles comprise unmanned aerial vehicles, the apparatus being configured to provide values of a planned flight altitude and field of view angles to respective payload cameras of the second vehicle and using the provided values to automatically determine a predetermined spatial offset for the second vehicle.

18. The apparatus as claimed in claim 10, configured to initially generate a vehicle formation as a line formation of the first vehicle, the second vehicle and at least one further vehicle, check a predetermined minimum distance between each of the vehicles of the vehicle formation, and move every other one of the vehicles backwards so that a sideway spacing between the vehicles remains substantially the same.

19. The apparatus as claimed in claim 14, comprising a handheld device.

20. A computer program comprising program instructions for causing a computer to perform a method comprising at least:
determining a first route from a first position to a target waypoint for a first vehicle;
determining a first planned route from a second position to a planned waypoint for a second vehicle following the first vehicle using a first mask positioned in a predefined manner relative to the first route;
determining that a direction of a second route for the first vehicle from the target waypoint to a next target waypoint is not substantially parallel with a direction of the first route;
determining a second planned route for the second vehicle using a second mask positioned in a predefined manner relative to the second route; and
controlling movement of the second vehicle in response to determining a relation between the first planned route and the second planned route.
